(19) United States
(12) Patent Application Publication
(10) Pub. No.: US 2026/0135081 A1
(43) Pub. Date: May 14, 2026

(54) PROCESSING AID FOR FREESTANDING ELECTRODE FABRICATION

(71) Applicant: ARKEMA INC., KING OF PRUSSIA, PA (US)

(72) Inventors: AYDA RAFIE, KING OF PRUSSIA, PA (US); RAMIN AMIN-SANAYEI, KING OF PRUSSIA, PA (US); KOUAKOU DESSALESSE AMANI, KING OF PRUSSIA, PA (US); ROBERT J. BARSOTTI, KING OF PRUSSIA, PA (US)

(21) Appl. No.: 19/434,362

(22) Filed: Dec. 29, 2025

Related U.S. Application Data
(63) Continuation of application No. PCT/US2025/047887, filed on Sep. 25, 2025.
(60) Provisional application No. 63/698,667, filed on Sep. 25, 2024.

(51) Int. Cl. H01M 4/133; H01M 4/02; H01M 4/1393; H01M 4/587; H01M 4/62; H01M 10/052; H01M 10/0525; H01M 10/054; H01M 10/42

(52) U.S. Cl. CPC H01M 4/133; H01M 4/1393; H01M 4/587; H01M 4/623; H01M 4/625; H01M 10/052; H01M 10/0525; H01M 10/054; H01M 10/4235; H01M 2004/027

(57) ABSTRACT

This invention discloses an anode film comprising: a processing aid having a number average particle size of less than 5 microns, anode active material, optionally a conductive carbon, and a fluoropolymer binder comprising PVDF and PTFE. The anode film is free of residue solvent. The anode film is made by a dry fabrication process.

### CROSS-REFERENCES TO RELATED APPLICATIONS

This application is a continuation of PCT/US2025/047887 which claims priority to US 63/69867, which are herein incorporated by reference.

### STATEMENT REGARDING FEDERALLY SPONSORED RESEARCH OR DEVELOPMENT

This application was made with United States Government support under DE-EE0009109 awarded by the Department of Energy of the United States. The United States Government has certain rights in the invention.

### FIELD OF THE INVENTION

The present invention relates generally to the field of energy storage devices. More particularly, the present invention relates to structures and methods for making dry binders and films for energy storage devices.

### BACKGROUND OF THE INVENTION

The processing rate of electrodes is often much lower than that of solution cast process due to concerns with the electrode's quality as well as the desire to reduce any irregularities in the fabricated electrodes. The irregularities in an electrode can be generally classified into two groups: 1) surface irregularities or defects due to lack of uniform dispersion of binder(s) and/or active materials and 2) gross irregularities which occurs due to uneven material flow or lack of sufficient malleability during the calendering step. The first one should be addressed during the powder mixing which is controlled by the PVDF type, PVDF particle size, as well as the use of processing aid(s) in the formulation. The second one occurs mostly during the calendering of electrode where the presence of processing aid allows the electrode to be rolled into uniform thin sheets without breaking, which in turn allows fabrication of high-quality, uniform and irregularity-free electrodes.

A proper processing aid should allow for faster processing rate by inducing malleability, reducing energy costs, and minimizing the occurrence of irregularities, hence reducing off-spec electrodes. However, many common processing aids are not compatible with the battery environment. On some occasions, PVDF powder has been used in the formulation of electrodes to improve its adhesion to the current collector. PVDF could also help with the PTFE particle dispersion within the electrode mixture prior to calendaring, however, it requires PVDF particle size to be in the nano size range, preferably less than 200 nm, to become an effective processing aid in making a uniform binder(s) dispersion during fabrication of the electrodes including cathode and anode.

PVDF-based polymers are semi-crystalline polymers used for many different applications such as extrusion, injection molding, fiber spinning, extrusion blow molding, blown film, and scaffolds to form articles. PVDF scaffolds are generally made via electrospinning of polymer solutions which often requires using toxic and flammable solvents. Fabricating scaffolds without using any solvent/liquid is advantageous especially when they are free of any residual solvent. Tensile strength and flexibility of articles made using scaffolds are important parameters for the purpose of handling, processing, and durability. The tensile strength of the articles made using scaffolds depends on the strength and quality of the scaffold, for example, electrode tensile strength, thickness, flexibility and mechanical properties are important to ensure that the roll-to-roll process is feasible. The volume resistivity of the electrodes is also an important parameter where the resistance inside the cell is directly correlated to the electronic conductivity within the electrodes. As a result, an electrode having low resistivity exhibits improved power density, energy density, and longevity.

The first cycle efficiency (FCE) in lithium-ion batteries (LIBs) and in Sodium-ion batteries (NIBs) refers to the percentage of charge that can be stored and then retrieved during the initial charging and discharging cycle. The FCE is an important parameter because the overall performance, especially cell capacity and longevity can significantly improve with FCE. Therefore, having a high FCE is very desirable.

Surprisingly, it was found that adding graphite based processing aids to the anode formulation can ease processing and allowed fabrication of high-quality, high strength anodes. In some embodiments, conductivity and quality of electrodes may be further improved by using PVDF having a primary particle size of less than 150 nm. The electrode can be freestanding or supported.

DOI: 10.1002/ente.202200732 describes a solvent-free graphite anode using a PTFE and PVDF binder. Adding PVDF increased the first cycle efficiency and helped the integrity of electrode even after PTFE was electrochemically reduced and degraded in the first lithiation cycle. This article demonstrates that the free-standing electrode film was formed when the dry mixture was hot rolled at 160° C. The hot roll was needed because the described process failed to produce PVDF-PTFE scaffolds and consequently needed high temperature to melt or soften the PVDF and form electrodes. Electrodes made via melting PVDF are lacking flexibility due to high PVDF crystallinity. For roll-to-roll processes of electrodes, flexibility is an essential characteristic.

DOI: 10.1021/acsaem.2c03755 describes the impact of process and material parameters on the friction and shear behavior of a powder blend plays a key role for process optimization. Specifically, the mixture homogeneity of a powder blend significantly impacts bulk characteristics such as the internal friction of the powder. PVDF binder is used as a binder that can act as a lubricant during dry electrode manufacturing in a roll mill, shearing during the process was promoted and the processability window could be enhanced. Graphite is also used as a shearing aid during calendering. In addition, the binder used in this work is PVDF, which is different from the PVDF-PTFE binder of the invention.

U.S. Pat. No. 20240105955A1 describes A method of fabricating a cathode of an energy storage device, comprising: combining a portion of a porous carbon material and at least one component of a composite binder material to form a first mixture, wherein the at least one component comprises at least one of polyvinylidene fluoride (PVDF), a PVDF co-polymer, and poly(ethylene oxide) (PEO); subjecting the first mixture to a high shear process; and adding polytetrafluoroethylene (PTFE) to the first mixture after the subjecting step to form a second mixture. Porous carbons can exhibit low electronic conductivity, and that is not a desired ingredient for electrode fabrication.

U.S. Pat. No. US20190237748A1 describes a dry electrode film comprising active material, and dry binder, wherein the dry binder comprises at least one of polytetrafluoroethylene (PTFE), carboxymethylcellulose (CMC), and polyvinylidene fluoride (PVDF).

WO2024072861A2 describes a binder for lithium-ion secondary battery electrode, comprising dry friable agglomerates comprising i) a first polymer comprising a tetrafluoroethylene polymer having a melt creep viscosity of at least about 0.5×10¹¹ poise, and; ii) a second polymer different from said first polymer.

WO2024110976A1 describes a process of making an electrode using an active material, and a conductive additive optionally with a first binder to obtain a first mixture; blending a fibrillating binder with the first mixture, followed by high shear mixing to obtain a second mixture; and quenching the second mixture and calendering to obtain the electrode.

The addition of processing additives to the anode forming compositions enhances the processing window and reduces irregularities of the anode film. Once example of “enhancing the processing” is that less calendering passes are needed to obtain the desired thickness when the processing aid is present in the anode formulation. The processing aid also helps to disperse the PVDF and PTFE uniformly. When the PVDF and PTFE is not uniformly distributed the performance is poor.

The processing aids for this invention comprise graphite-based processing aids. The process used in this invention is a dry method where all the component materials used are dry powder materials. No solvents are used in the method.

### BRIEF DESCRIPTION OF FIGURES

FIG. 1 is a picture of the functionalized PVDF (of example 1) and PTFE alloy.

FIG. 2 is a SEM picture of the PVDF-PTFE scaffold material of Example 5

FIG. 3 is a picture of a porous mat made with the functionalized PVDF and PTFE

FIG. 4 is a picture of Kynar 741-PTFE blend (example 12).

FIG. 5 is a SEM picture of Kynar 741-PTFE blend (example 12).

FIG. 6 is a picture of porous mats made with Kynar741-PTFE shows the porous mat made from example 13.

### SUMMARY OF THE INVENTION

This invention describes anode films for energy storage devices and compositions of the anode films that use a binder comprising a fluoropolymer binder and at least one processing aid. The anodes are processed without any solvent/liquid and are free of any residual solvent. The anode film of this invention is comprised of processing aid, PVDF and at least 0.1 wt % PTFE, and anode active materials and optionally conductive carbon. The electrodes can be free standing or supported by a current collector or substrate.

In some embodiments the electrode film can be free standing or supported by a current collector or substrate.

The anode film of this invention is made by a dry fabrication process.

In a preferred embodiment, the PVDF used to prepare the anode composition, contains functional groups and preferably has a particle size of less than 150 nm, and more preferably less than 120 nm. The processing aid used to prepare the anode film of this invention is a graphite-based material having a number average particle size of less than 5 micron, preferably 4.5 microns or less, more preferably 4 microns or less. Average particle size is reported using the largest dimension of the particle using SEM (Scanning Electron Microscope).

In some embodiments of the invention, in addition to the processing aid, a binder which comprises PVDF and PTFE, the PVDF comprises a functionalized PVDF, and the PVDF-PTFE may be sheared and may form as a single phase of material under SEM. The PVDF-PTFE blend may be in the form of a scaffold where the PVDF comprises a functionalized PVDF.

This invention discloses an anode composition for fabricating anodes for energy storage devices using PVDF, PTFE along with graphite-based processing aid(s). The anodes are processed without any solvent/liquid and are free of any residual solvent. The anodes of this invention comprise PVDF, PTFE, anode active materials, and at least 0.1 wt % graphite-based processing aid(s). The number average particle size of the processing aid of this invention is from 10 nanometers up to 20 microns (by SEM) depending on the formulation requirements. The anode made by using the PVDF and PTFE binder and processing aid(s) of this invention exhibits higher tensile strength, higher electronic conductivity, ease of processing, and lower irregularities than those disclosed in the prior art.

The PVDF used in the invention preferably has a number average primary particle size between 50 to 300 nm for emulsion grade, and 2 to 200 μm for suspension grade PVDF.

### Various Embodiments of the Invention

First embodiment of the invention provides an anode film comprising: a graphite-based processing aid, anode active material, optionally a conductive carbon, and a fluoropolymer binder comprising PVDF and PTFE, wherein the weight ratio of PVDF to PTFE in the anode is 10:90 to 95:5; wherein the anode is free of solvent residue, and wherein the total binder amount is from 1 wt % to 10 wt % of the anode film, wherein the processing aid has a number average particle size of less than 5 microns.

Embodiment 2: The anode film of embodiment 1, wherein the processing aid has an ID/IG of less than 1.6.

Embodiment 3: The anode film of embodiment 1, wherein the processing aid has an ID/IG of less than 1.4.

Embodiment 4: The anode film of any one or more of embodiments 1-3, wherein the processing aid is a graphite or graphite-based processing aid.

Embodiment 5: The anode film of any one or more of embodiments 1-3, wherein the processing aid is selected from the group consisting of graphite powder, graphene, nano graphite, carbon nanotubes furnace black, acetylene black, carbon nanotubes (CNT), carbon nanofibers (CNF), fine graphite powder, vapor deposited graphite fibers, Ketjen carbon black and combinations thereof.

Embodiment 6: The anode film of any one or more of embodiments 1-5, wherein the processing aid has a number average particle size of less than 4.0 micrometers.

Embodiment 7: The anode film of any one or more of embodiments 1-4, wherein the processing aid is a flaked synthetic graphite having a number average particle size of less than 4.0 micrometers.

Embodiment 8: The anode film of any one or more of embodiments 1-7, wherein the amount of processing aid is from 0.1 to 20 wt % based on the weight of the anode film.

Embodiment 9: The anode film of any one or more of embodiments 1-8, wherein the amount of processing aid is from 0.5 to 5 wt % based on the weight of the anode film.

Embodiment 10: The anode film of any one or more of embodiments 1-9, wherein the PVDF is a homopolymer or vinylidene fluoride copolymer.

Embodiment 11: The anode film of any one or more of embodiments 1-9, wherein the PVDF is a vinylidene fluoride copolymer comprising at least 50 mole percent of vinylidene fluoride copolymerized with at least one comonomer.

Embodiment 12: The electrode of any one or more of embodiments 1-11, wherein the PVDF is a functionalized PVDF.

Embodiment 13: The anode film of any one or more of embodiments 1-12, wherein the weight ratio of PVDF to PTFE is from 25:75 to 90:10.

Embodiment 14: The anode film of embodiment 12, wherein the functional group comprises a carboxylic group or salt or ester thereof.

Embodiment 15: The anode film of embodiment 12, wherein the functional group comprises a phosphate or sulfonate.

Embodiment 16: The anode film of any one or more of embodiments 1-5, wherein the amount of functional groups is at least 0.1 mole percent to 10 mole percent, preferably 0.2 to 5 mole percent based on VDF monomer units.

Embodiment 17: The anode film of any one or more of embodiments 1-16, wherein fluoropolymer binder comprising the PTFE and the functionalized PVDF is in the form of a scaffold.

Embodiment 18: The anode film of any one or more of embodiments 1-17, wherein the anode comprises 1 weight % to 6 weight % of the fluoropolymer binder based on weight of the anode film.

Embodiment 19: The anode film of any one or more of embodiments 1-18, wherein the anode active material comprises synthetic graphite, natural graphite, hard carbon, soft carbon, graphene, graphene oxide, silicon, silicon oxides, tin, tin oxides, germanium, lithium titanate, or mixtures thereof.

Embodiment 20: The anode film of any one or more of embodiments 1-18, wherein the anode active material comprises graphite and has a number average particle size of greater than 5 microns or greater than 7 microns.

Embodiment 21: The anode film of any one or more of embodiments 1-20, wherein the anode film contains conductive carbon.

Embodiment 22: An energy storage device comprising the anode film of any one or more of embodiments 1-21, wherein the energy storage device comprises a lithium-ion battery.

Embodiment 23: An energy storage device comprising the anode film of any one or more of embodiments 1-21, wherein the energy storage device comprises a sodium-ion battery.

Embodiment 24: An energy storage device comprising the anode film of any one or more of embodiments 1-21, wherein the energy storage device comprises a lithium sulfur battery.

Embodiment 25: A method of fabricating an anode film of an energy storage device, comprising: combining a processing aid, anode active material, optionally conductive carbon, and PVDF to form a first mixture, adding PTFE to the first mixture to form a second mixture; and subjecting the second mixture to a shearing process to form a dry anode forming mixture; comprising PVDF and PTFE; wherein no liquid is used in the process.

Embodiment 26: The method of embodiment 25, wherein the processing aid is selected from the group consisting of graphite powder, graphene, nano graphite, furnace black, acetylene black, carbon nanotubes (CNT), carbon nanofibers (CNF), vapor deposited graphite fibers, Ketjen carbon black and combinations thereof.

Embodiment 27: The method of embodiment 25 or 26, wherein the processing aid has a number average particle size of less than 5.0 micrometers.

Embodiment 28: The method of embodiment 25 or 26, wherein the processing aid is a flaked graphite having a number average particle size of less than 5.0 micrometers or less than 4.0 micrometers.

Embodiment 29: The method of any one or more of embodiments 25-28, wherein the amount of processing aid is from 0.1 to 20 wt % based on the weight of the anode film.

Embodiment 30: The method of any one or more of embodiments 25-28, wherein the amount of processing aid is from 0.5 to 5 wt % based on the weight of the anode film.

Embodiment 31: The method of any one or more of embodiments 25-30, wherein each of the combining and the adding steps comprises blending at a temperature of 10° C. to 120° C.

Embodiment 32: The method of any one or more of embodiments 25-31, wherein the shearing comprises jet-milling.

Embodiment 33: The method of any one or more of embodiments 25-31, wherein the shearing comprises ball-milling and uses milling media.

Embodiment 34: The method of any one or more of embodiments 25-33, wherein combining further comprises combining a conductive carbon with the active material and the PVDF to form the first mixture.

Embodiment 35: The method of any one or more of embodiments 25-34, wherein the PVDF is a functionalized PVDF.

Embodiment 36: The method of any one or more of embodiments 25-35, wherein the PVDF is a PVDF copolymer.

Embodiment 37: The method of any one or more of embodiments 25-36, further comprising calendering the anode film mixture to form an anode film.

Embodiment 38: The method of any one or more of embodiments 25-37, further comprising disposing the anode film over a current collector to form an electrode.

Embodiment 39: The method of embodiment 38, wherein the disposing comprises laminating the anode film to the current collector.

Embodiment 40: The method of any one or more of embodiments 25-39, wherein a mass ratio of the PVDF to PTFE is 10:90 to 95:5.

### DETAILED DESCRIPTION OF THE INVENTION

The references cited in this application are incorporated herein by reference.

Percentages, as used herein are weight percentages (wt %), unless noted otherwise, amounts in “ppm” are weight by weight based.

The term “fluoropolymer” refers to polymers and copolymers (including polymers having two or more different monomers, including for example terpolymers) containing at least 50 mole percent of fluoromonomer units. The copolymers may be homogeneous, heterogeneous, or random, and may have a gradient distribution of co-monomer units.

“Copolymer” is used to mean a polymer having two or more different monomer units, including terpolymers and higher degree polymers. “Polymer” is used to mean both homopolymer and copolymers.

“PVDF” means polyvinylidene fluoride, this includes both homopolymer and copolymers unless otherwise noted. “VDF” means vinylidene fluoride.

Dispersion means a dispersion or suspension of polymer particles in water. No oil phase or other organic phase is present.

Solids content means the matter that remains after drying of the dispersion. The solids content of the aqueous dispersion was measured by means of gravimetry method using a HG63 moisture analyzer from Mettler Toledo. A known quantity of the latex is dried and the change in weight is measured. A known weight of the latex (Q) is dried and the change in weight is measured (D). % Solids=[(Q−D)/Q]*100.

Melt viscosity are measured according to ASTM D3835 by a capillary rheometry at 230° C., and at a shear rate of 100 sec⁻¹.

Thermogravimetric Analysis (TGA) is used to measure the 5% weight decomposition temperature. TGA was carried out from room temperature to 800° C. at a heating rate of 20° C./min under steady state flow of nitrogen.

Number average particle size can be determined using scanning electron microscope (“SEM”).

Particle size is reported as the largest dimension of the particle using SEM (Scanning Electron Microscope).

The infrared spectra were obtained using a Fourier transform infrared (FTIR) spectrometer (Nicolet iS50, Thermo-Fisher Scientific), equipped with a Thunderdome Diamond ATR accessory. The spectra were collected with a resolution of 4 cm⁻¹ with 32 scans per spectrum. For the analysis, the regions 837-840 cm⁻¹ (CH₂ and CF₂ vibrations) as containing a high contribution from non-α and 763-765 cm⁻¹ (CF₂ and CCC vibrations) as containing mainly a contributions are selected. For each spectrum, the maximum peak height (the highest peak within the respective range) are determined (the two selected regions) and a ratio is calculated.

The ultimate tensile strength (tensile at break, psi) and through plane resistivity of the films were measured using an Instron 3343 series. The tensile bar was a dog bone, as described in ASTM D1708. The speed used for this experiment was 12.7 mm/min. The samples were processed at room temperature and the ultimate tensile strength was measured in a controlled environment, where the dew point was kept at −5° C. The samples were not conditioned before the ultimate tensile test.

For through-plane resistivity, the sample was punched to 1″ diameter circles and was placed between two gold plated sheets. The resistance between the two plates, at different applied force, is measured using a Yoogawa resistance meter.

PVDF exhibits three main crystalline phases (α, β, and γ). As a result, PVDF can have various characteristics (solution viscosity, Tm, Tc and etc.) depending on the crystalline structure and ratio of crystalline phases. Changing the PVDF crystalline phase induces unique properties. For example, β phase induces piezoelectric, and pyroelectric properties. Also changing the PVDF crystalline phase from α to non-α, could improve adhesion properties of this semicrystalline polymer when used as a binder for battery electrodes. In some embodiments of the invention, the percentage of non-α phase of functionalized PVDF is higher than 70% after shearing with PTFE. The percentage of non-α phase increases by shearing PVDF with PTFE. Even after shearing with PTFE, the non-α phase is preferably higher than 70% for the functionalized PVDF. In contrast for non-functionalized PVDF we find non-α phase to be lower than 70% even after being blended with PTFE. Percent of crystalline phases are determined using FTIR spectra.

Scaffold means a 3-dimensional porous fibrous web structure or matrix formed by the polymer alloy when they are fibrillized by shearing. The scaffold appears as a fibrous web under SEM.

Polymers and polymer alloys capable of fibrillization are commonly referred to as “fibrillizable binders’ or “fibril-forming binders.” Fibril-forming binders find use with other powder like materials. Fibrillization of the binder particles produces fibrils that eventually allow formation of a matrix or lattice for supporting a resulting composition of matter. In the prior art, solvents, and/or other liquids, are added so that subsequent shear forces applied to a resulting mixture are sufficient to fibrillize the particles. The use of solvents is not desirable, especially if the solvents used are hazardous. In some embodiments of the invention when the PTFE/PVDF mixture is subjected to shear, the result is an alloy. In some embodiments the alloy is in the form of a scaffold. In the present invention, no solvents or liquids are used to create the alloy or the alloy in the form of a scaffold.

By alloy we mean a single-phase homogeneous physical blend of materials that exhibits a single-phase composition of PVDF-PTFE scaffolds according to SEM imaging.

The PTFE used in the present invention is expandable PTFE also called fibrillizable PTFE meaning it can be expanded or fibrillized by stretching it in one or more directions usually through shearing without melting. See for example U.S. Pat. No. 11,527,747 or U.S. Pat. No. 3,962,153.

The invention provides a composition comprising a processing aid, anode active material and a binder comprising PVDF and PTFE (“PVDF-PTFE blend”).

The invention provides an article comprising the inventive composition.

The invention provides an anode film comprising a processing aid, anode active material and a binder comprising PVDF and PTFE.

In some embodiments the invention provides an anode film comprising a processing aid, anode active material and PTFE and a PVDF where the PVDF comprises a functionalized PVDF. The PTFE and a functionalized PVDF may be in the form of a scaffold.

The invention provides a method of making an anode film comprising a processing aid, anode active material, and a binder comprising PVDF and PTFE.

The anode film of this invention is free of solvent residuals.

### PVDF-Based Material

The term “vinylidene fluoride polymer” or “polyvinylidene fluoride” used herein includes homopolymers, copolymers, and functionalized polymers within its meaning. Such copolymers include those containing at least 50 mole percent of vinylidene fluoride, preferably greater than 65 mole percent or 90 mole percent or greater, copolymerized with at least one comonomer selected from the group consisting of tetrafluoroethylene (TFE), trifluoroethylene (TrFE), chlorotrifluoroethylene (CTFE), perfluorobutylethylene (PFBE), hexafluoropropene (HFP), vinyl fluoride (VF), pentafluoropropene, 2,3,3,3-tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, one or more of partly or fully fluorinated alpha-olefins such as 3,3,3-trifluoro-1-propene, 2-trifluoromethyl-3,3,3-trifluoropropene, 1,2,3,3,3-pentafluoropropene, 3,3,3,4,4-pentafluoro-1-butene, hexafluoroisobutylene (HFIB), fluorinated dioxoles, such as perfluoro (1,3-dioxole) and perfluoro (2,2-dimethyl-1,3-dioxole) (PDD), partially- or per-fluorinated alpha olefins of C4 and higher, partially- or per-fluorinated cyclic alkenes of C3 and higher, partly fluorinated allylic, or fluorinated allylic monomers, and combinations thereof.

### Functionalized PVDF

In some embodiments a functionalized PVDF is used to make the anode film.

Fluoropolymers, for example those based on vinylidene fluoride CF2=CH2 (VDF) or tetrafluoroethylene CF2=CF2 (TFE) are known to have excellent mechanical stability properties, very great chemical inertness, low surface energy, electrochemical stability, and good aging resistance. These qualities are exploited in various end-use applications.

Unfortunately, the excellent properties provided by fluoropolymers can also limit the applications in which they can be used. For example, it is difficult to bond fluoropolymers or combine them with other materials or alloy them with each other.

Some embodiments of the present invention use functionalized PVDF. By “functionalized” or “functional groups” we mean that groups containing at least one atom other than C, H or F are part of at least one monomeric unit of the fluoropolymer. Atoms, in addition to any one or more of C, H or F, in the functional groups include at least one of O, N, S, or P. Useful functional groups that can be incorporated into a fluoropolymer include, but are not limited to, carboxylic, hydroxyl, siloxane, ether, ester, sulfonic, phosphoric, phosphonic, sulfuric, amide, nitrile, epoxy groups, alkylene oxide (such as ethylene oxide or propylene oxide) or a mixture thereof. The carboxylic group includes the acid form, the salt form, the ester form, and anhydride form. In some embodiments the functional group contains an oxygen.

Carboxylic group includes the acid form, the salt form, the ester form and anhydride form.

Functionality (functional groups) may be incorporated into a fluoropolymer by different means, such as by copolymerization, post-polymerization grafting and use of low molecular weight functionalized polymer chain transfer agents.

Direct copolymerization of a monomer having a functional group (“functional monomer”) with the fluoromonomers can result in a functional fluoropolymer. Post-polymerization grafting mechanism, such as the grafting of maleic anhydride onto a polyvinylidene fluoride homopolymer or copolymer, as described in U.S. Pat. No. 7,241,817 can be used to functionalize a fluoropolymer. WO 2013/110740 and U.S. Pat. No. 7,351,498 further describe functionalization of a fluoropolymer by monomer grafting or by copolymerization.

Low molecular weight functionalized polymer chain transfer agents, as described in U.S. Pat. No. 11,643,484, can be used in the polymerization of fluoromonomers, as a means of both controlling the resulting fluoropolymer molecular weight and providing improved properties to the fluoropolymer. Useful functional chain transfer agents include, but are not limited to, polyacrylic acid, polylactic acid, polyphosphonic acid, polysulfonic acid, and polymaleic acid.

Functional monomers may include, but are not limited to, an acrylic based glycol ester, preferably the acrylic based glycol ester comprises at least one of polyethylene glycol acrylate (PEGA), polyethylene glycol methacrylate (PEGMA), polypropylene glycol acrylate (PPGA), or polypropylene glycol methacrylate (PPGMA).

Examples of functional monomers include, but not limited to, ethylenically unsaturated ionic monomer comprising at least one functional group selected from carboxylate, sulfonate, sulfate, phosphate, phosphonate, and/or acids, and/or salts, and/or anhydrides thereof.

Examples of acid functionalized monomers include ethylenically unsaturated monomers comprising at least one acid functional group. Examples of acid functionalized monomers include (meth) acrylic acid, beta-polycarboxy ethyl acrylate, 4-styrene sulfonic acid, 2-acrylamido-2-methylpropane sulfonic acid, vinyl phosphonic acid, vinyl sulfonic acid, mono-esters of itaconic acid, maleic acid, fumaric acid, and mixtures thereof.

Examples of functional monomers further include but are not limited to:
(i) ethylenically unsaturated ionic monomer comprising at least one functional group; examples include (meth) acrylic acid, 2-carboxyethyl acrylate, 2-polycarboxy ethyl acrylate, mono-ester of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth) acrylate, polyalkylene glycol allyl ether phosphate, vinylphosphonic acid, 2-(methacryloyloxy)ethyl phosphonic acid; and/or acids, and/or salts, and/or anhydrides thereof; and mixtures thereof.
(ii) oxyalkylated monomer with ethylenic unsaturation and terminated by a hydrogen or hydrophobic aryl or alkyl chain, having the following formula:

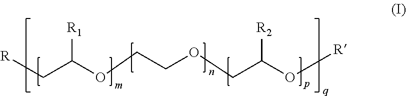

wherein: m and p represent a number of alkylene oxide units of from 0 and 15, n represents a number of ethylene oxide units of from 5 and 15, q represents a whole number at least equal to 1 or greater, R1 and R2 represent methyl or ethyl, and R′ represents a hydrogen or hydrophobic aryl chain with 5 to 60 carbon atoms or an alkyl chain end with 1 to 5 carbon atoms; R represents a group comprising at least one polymerizable olefinic unsaturation, preferably a group chosen from acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof, and
(iii) N-alkylol(meth)acrylamide, vinyl glycidyl ether, allyl glycidyl ether, glycidyl (meth) acrylate, diacetone acrylamide, acetoacetoxyethyl methacrylate, (meth) acryloxyalkyltrialkoxysilanes, vinyltrialkoxysilanes, and mixtures thereof.

The functionalized polyvinylidene fluoride comprises polymerized vinylidene fluoride units and preferably from 0.1 to 10 mole percent of functional groups in the polymer. The presence of functional monomer or functional group on the fluoropolymer can be detected by means of NMR.

The melt viscosity of the functionalized PVDF is at least 5 kPoise, preferably at least 10 kPoise measured according to ASTM D3835 by a capillary rheometry at 230° C., and at shear rate of at 100 1/s.

### Anode Active Material

The anode active material comprises electrochemically active material in the form of a particulates. The anode active materials are selected from conventional materials known in this field. The anode electrochemically active materials include, but is not limited to, graphite based materials having an average particle size of greater than 5 microns (such as synthetic graphite, natural graphite, and graphene), hard carbon amorphous silicon, semi crystalline silicon, silicon oxides, silicon nanowires, silicon-carbon composite, tin, tin oxides, germanium, lithium titanate, mixtures or combinations of the aforementioned materials, and/or other materials known in the art or described herein as suitable for use as the anode in a lithium sulfur battery, lithium ion battery, or a sodium ion battery. These particulates may include active materials, i.e., materials capable of intercalating (accepting) lithium/sodium ions, and conductive materials. The anode film may be used in a lithium or sodium-ion capacitor and/or a lithium or sodium-ion battery or lithium sulfur battery. The electrode film can comprise from about 50 weight percent up to 99 weight percent of the anode active materials. These anode active materials are typically in the form of powders.

Anode forming material means anode active material plus conductive carbon plus processing aid plus binder.

### Conductive Carbon

The conductive carbons are widely used in positive and negative electrodes to improve the electronic conductivity of electrodes. Examples of conductive carbon include but are not limited to, carbon black, onion like carbon, activated carbon. Conductive carbon and carbon black are essentially formed out of primary carbon particles which are spherical in shape and arranged into aggregates and agglomerates. These conductive carbons are used for enhancing electronic conductivity and therefore lower the charge transfer resistance of the cell. The typical loading level of the conductive carbon, when incorporated, relative to the anode forming material in the anode is usually within the range of 0 to 20% by weight, 0.1% by weight to 20% by weight, and more preferably within the range of 0.5% by weight to 10% by weight, based on the total amount of the anode-forming materials. These anode forming materials are typically in the form of solid powders. “Anode forming materials” means anode active material and conductive carbon if used and processing aid and binder. In any case the total amount of all materials in the anode film adds up to 100%.

### Graphite-Based Processing Aid

Conductive carbon such as Super-P and Denka-black are commonly used in positive and negative electrodes to decrease electronic resistivity within the electrode. However, graphite-based materials not only can improve electronic conductivity within the electrode, but also, they surprisingly enable fabrication of high conductivity and high-quality anodes.

“Graphite” refers specifically to a crystalline form of carbon with a layered structure that makes it highly conductive due to its delocalized electrons. The graphite-based processing aid, such as the vapor grown carbon fibers (VGCFs), or vapor grown carbon nanofibers (VGCNFs), are cylindrical nanostructures with graphene layers arranged into cylinders. The Ketjen carbon black contains a network of disordered graphene-sheets stacks.

Flaked graphite refers to a form of graphite that has a flake-like morphology, which appears as flat, plate-like particles.

Non-limiting examples of graphite-based processing aid include graphite powder, graphene, graphene oxide, nano graphite, carbon nanotubes furnace black, acetylene black, carbon nanotubes (CNT), carbon nanofibers (CNF), fine graphite powder, vapor deposited graphite fibers, and Ketjen carbon black. Graphitizing carbons can be used as the graphite-based processing aids. Flaked graphite can be used as the graphite-based processing aid.

The typical loading level of the processing aid in anode formulation can vary depending on the process and processing condition and usually is between 0.1% to 20% by weight, preferably within the range of 0.5% to 10% by weight, and more preferably is 0.5 to 5% based on the weight of the anode forming materials.

Graphitizing carbons are soft and non-porous, while non-graphitizing carbons are hard, low-density materials. The degree of carbon ordering (graphitization) can be obtained from Raman spectroscopy. The D- and G-modes in the area of 1200-1700 cm⁻¹ appear for each sample at different positions and with different intensities depending on their structural features. The degree of carbon ordering (graphitization) can be obtained from the D- and G-mode FWHM (full-width at half-maximum) values and the intensity ratio ID/IG. A high ID/IG ratio together with low FWHM values indicate a high degree of structural order within the carbon. As an example, C-NERGY™ KS6L (Imerys) has a carbon ordering (ID/IG) of 0.2, whereas this ratio is 2.6 for Super P, indication of a very high graphitization for KS6L.

The processing aid of this invention has an ID/IG of less than 1.6, preferably less than 1.4. Above 2 is considered conductive carbon.

Some of the Graphite-based processing aids are composed of layers of carbon atoms that are arranged in 6-membered, hexagonal rings. In a graphite-based processing aid, each carbon atom is joined to three other carbon atoms by covalent bonds which in turn the carbon atoms form layers with a hexagonal arrangement of atoms. These rings are attached to one another on their edges. Layers of fused rings can be modeled as an infinite series of fused benzene rings (without the hydrogen atoms). The electrical conductivity perpendicular to the layers is consequently about 1000 times lower than that of on the planes. On the other hand, the conductive carbon, typically in the form of “carbon black,” is structured with small, primary carbon particles that are highly aggregated, forming a complex network of branched chains with many spaces between them, which allows for efficient electron transport and contributes to its electrical conductivity.

In some instances, the processing aid has a number average particle size (by SEM) of less than 5.0 micrometers. In some instances, the processing aid has a number average particle size of less than 4.0 micrometers.

### Ease of Processing:

In addition to process design, material selection plays an important role in powder flow, binder dispersion, shear behavior, flexibility of the film, and film processing. For powders, such as PVDF in powder form, addition of graphite based processing aids can widen the processing window by enabling the uniform dispersion of the powders, reducing the number of passes required for the film to reach the target thickness, and reducing the wear of forming tools. Without the use of a proper processing aid, reducing the film thickness becomes very challenging as the calendering of the film, resulting in over densification which has several consequences: a) low porosity of the film leading to an electrode that can significantly reduce ionic diffusion, b) active material cracking, resulting in cell instability, and c) problems in film handling or winding because of poor flexibility.

In some embodiments a PVDF-PTFE blend is made by combining PVDF in powder form and PTFE in powder form, and then shearing the blend at a temperature of between 10° C. and the melting temperature of the PVDF, preferably between 15° C. and 120° C. In some embodiments the PVDF is a homopolymer or copolymer (without functional groups) and in some embodiments the PVDF is functionalized PVDF. For example, the PVDF-PTFE blend can be made by mixing first at low shear followed by high-shear mixing until fibers are formed. For example, at a laboratory scale, the powder was first mixed at 500 rpm for 1 minute, with 2 zirconia beads, followed by shearing at 2000 rpm for 2 mins with total of 7 zirconia beads in a Thinky mixer resulting in PVDF-PTFE scaffolds, at ambient temperature.

High Shear mixing or blending is used to blend PVDF and the PTFE together. In some embodiments the blend has a scaffold structure. Batch mixers and in-line mixers can be used. At a laboratory scale, this was accomplished, by ball milling using mixing media. The bulk material is sheared to produce scaffolding in a high-energy ball mill using milling media like balls or beads. There is a variety of milling media materials such as: Steel (chrome steel, and stainless steel, 304SS and 316SS) or Ceramics (agate, alumina, yttria stabilized zirconia, zirconium silicate, zirconia toughened alumina, and tungsten carbide).

### Manufacture of Anode Film

The method of fabricating an anode of an energy storage devices comprises combining a processing aid, an anode active material, optionally conductive carbon, and PVDF to form a first mixture, adding PTFE to the first mixture to form a second mixture; and subjecting the second mixture to a shearing process to form a dry anode forming mixture. The process is a dry process. No liquid is used in the process. All components are in a powder form.

The processing aid can be any processing aid described above.

The anode active material can be any anode active material described herein.

In some embodiments the PVDF is a homopolymer or copolymer (without functional groups) and in some embodiments the PVDF is functionalized PVDF. The functionalized PVDF can be functionalized PVDF described herein.

The steps of the method can be performed a temperature of between 10° C. to 120° C.

The shearing can be done via jet-milling.

The shearing can be done via ball-milling and may use milling media.

The method may further comprises adding a conductive carbon with the active material and the PVDF.

The resulting material may be calendered to form an anode film. The anode film may be disposed over a current collector to form an anode. This may be done by laminating the anode film to the current collector.

### EXAMPLES

### Example 1 Production of PVDF with Particle Size Below 100 nm

To a 7.5-liter, stainless steel reactor was added 4200 g of water and 0.5 g of non-ionic emulsifiers of Pluronic® 31R1 (from BASF) and 3.5 g of Poly (Propylene Glycol) Monomethacrylate (“PPGMA”). The mixture was purged with nitrogen and agitated for 0.5 hours. The reactor temperature was raised to 105° C. for deoxygenation. The reactor sealed, while agitation was continued, the temperature was set at 100 C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to initiate the polymerization. The initiator solution feed rate was set at about 60 g/h to maintain the reaction throughout the rest of the polymerization. Total initiator was 300 milliliters. The reaction pressure was maintained at 650 psig by adding as needed vinylidene fluoride. After a total of 1500 g of VDF was added to the reactor, the monomer feed was stopped. For a period of 10 minutes, agitation was continued, and the temperature was maintained. The agitation and heating were discontinued. After cooling to room temperature, surplus gas was vented, and the reactor was emptied of dispersion through a stainless-steel mesh screen (208 micron). The PVDF latex has 29% solid contents. The PVDF powder has a melt viscosity of greater than 27 kPoise. The average primary particle size is 82 nm. Melting temperature was measured to be 164° C.

### Example 2 Production of PVDF/HFP Copolymer with Particle Size Below 100 nm

To a 7.5 liter stainless steel reactor was added 4200 g of water and 0.5 g of non-ionic emulsifiers of Pluronic® 31R1 (from BASF) and 3.5 g PPGMA. The mixture was purged with nitrogen and agitated for 0.5 hours. The reactor temperature was raised to 105° C. for deoxygenation. The reactor sealed, while agitation was continued, the temperature was set at 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. The initiator solution feed rate was set at about 60 g/h to maintain the reaction rate throughout the rest of the polymerization. Total initiator was 290 milliliters. The reaction pressure was maintained at 650 psig by adding as needed vinylidene fluoride. After a total of 365 g of VDF was added to the reactor, the VDF feed was stopped and 273 g of HFP monomer is added to reactor and then was topped with VDF to reach 1500 g total of VDF. For a period of 10 minutes, agitation was continued, and the temperature was maintained. Then agitation and heating were discontinued. After cooling to room temperature, surplus gas was vented, and the reactor was emptied of dispersion through a stainless-steel mesh screen (208 micron). The PVDF latex has 31% solid contents. The PVDF powder has a melt viscosity of 25 kPoise (at 100 1/s), a melting temperature of 162° C. and primary particle size of 87 nm.

### Example 3 Production of PVDF (with PPGMA and PAA) with Particle Size Below 100 nm

To a 7.5 liter, stainless steel reactor was added 3000 g of water and 0.5 g of non-ionic emulsifiers of Pluronic 31R1 (from BASF) and 3.0 g of PPGMA. The mixture was purged with nitrogen and agitated for 0.5 hours. The reactor temperature was raised to 105° C. for deoxygenation. The reactor sealed, while agitation was continued, the temperature was set at 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. Total initiator was 255 milliliters. The initiator solution feed rate was set at about 60 g/h to maintain the reaction rate throughout the rest of the polymerization. The reaction pressure was maintained at 650 psig by adding as needed vinylidene fluoride. After a total of 800 g of VDF was added to the reactor, a 5 wt % solution of polyacrylic acid (Sokalan CP-10 from BASF) having a weight average molecular weight of ˜4000 in water was fed to the reactor at 200 ml/hr while the feeding of VDF continued. Addition of polyacrylic acid solution was stopped when a total of 195 ml of PAA solution was reached. Addition of VDF was stopped when the total of VDF fed reached 1700 g. For a period of 10 minutes, agitation was continued, and the temperature was maintained. Then agitation and heating were discontinued. After cooling to room temperature, surplus gas was vented, and the reactor was emptied of dispersion through a stainless-steel mesh screen (208 micron). The PVDF latex has 33% solid contents. The PVDF powder has a melt viscosity of 28 kPoise (at 100 1/s), a melting temperature of 164° C. and a primary particle size of 95 nm.

### Example 4 Production of PVDF (PPGMA and PAM) with Particle Size Below 100 nm

To a 7.5 liter, stainless steel reactor was added 3000 g of water and 0.5 g of non-ionic emulsifiers of Pluronic 31R1 (from BASF) and 3.0 g of PPGMA. The mixture was purged with nitrogen and agitated for 0.5 hours. The reactor temperature was raised to 105° C. for deoxygenation. The reactor sealed, while agitation was continued, the temperature was set at a 100° C. The reactor was charged with vinylidene fluoride to a pressure of 650 psig (4.5 MPa); an aqueous initiator solution, comprised of 2 wt. % in potassium persulfate and 2 wt % in sodium triacetate, was charged at 500 g/hr to start the polymerization. Total initiator was 270 milliliters. The initiator solution feed rate was set at about 60 g/h to maintain the reaction rate throughout the rest of the polymerization. The reaction pressure was maintained at 650 psig by adding, as needed, vinylidene fluoride. After a total of 800 g of VDF was added to the reactor, 2% wt/wt of solution of alkyl methacrylate phosphate (Sipomer® PAM 4000 by Solvay) in water and then was fed to the reactor at 100 ml/hr while the feeding of VDF continued for a total of 285 ml of Sipomer® PAM 4000 solution. Addition of VDF and PAM 4000 solution were stop when the total of fed VDF reached 1700 g. For a period of 10 minutes, agitation was continued, and the temperature was maintained. The agitation and heating were discontinued. After cooling to room temperature, surplus gas was vented, and the reactor was emptied of dispersion through a stainless-steel mesh screen (208 micron). The PVDF latex has 28% solid contents. The PVDF powder has melt viscosity of 29 kPoise (at 100 1/s), a melting temperature of 161° C. and an average primary particle size of 78 nm.

### Example 5 Functionalized PVDF-PTFE Scaffold

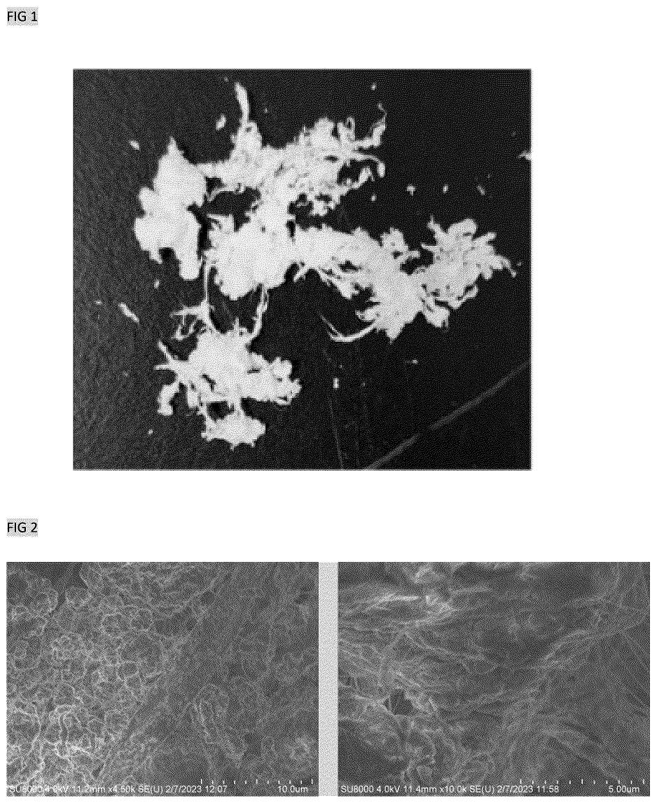

PVDF-PTFE scaffold was made by shearing 3 g of PVDF functionalized polyvinylidene fluoride fluoropolymer powder (functionalized with PPGMA) of example 1 and 1 g of PTFE powder (Teflon® PTFE 601X from Chemours) with total of 7 Zirconia beads of 6.5 mm, using a planetary mixer (Thinky ARE-310). The powder was first mixed at 500 rpm for 1 minute, with 2 zirconia beads, followed by shearing at 2000 rpm for 2 minutes with total of 7 zirconia beads resulting in formation of PVDF-PTFE scaffolds, FIG. 1. The PVDF-PTFE scaffolds of this example is a fibrous powdery material. FIG. 2 is a SEM of the PVDF-PTFE scaffold material of Example 5, based on the SEM pictures, no PVDF spherical particles are observed in the scaffold. This shows that the PVDF is physically alloyed with the PTFE to form the functionalized PVDF-PTFE scaffolds.

### Example 6 Making PVDF-PTFE Porous Freestanding Mat

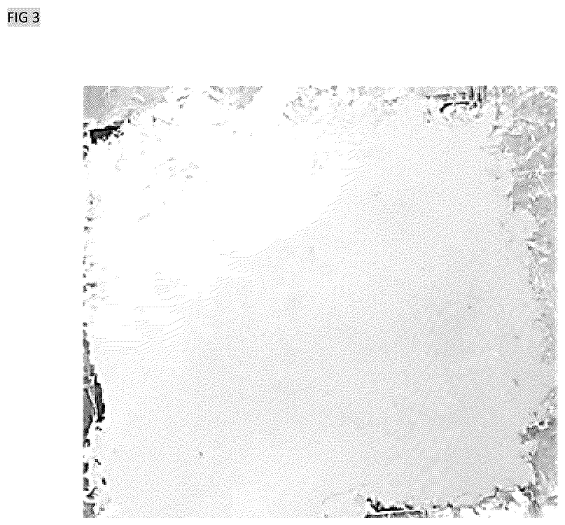

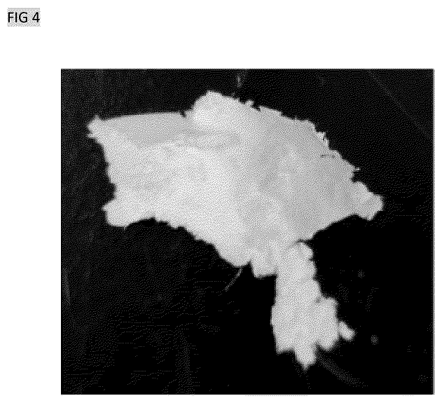

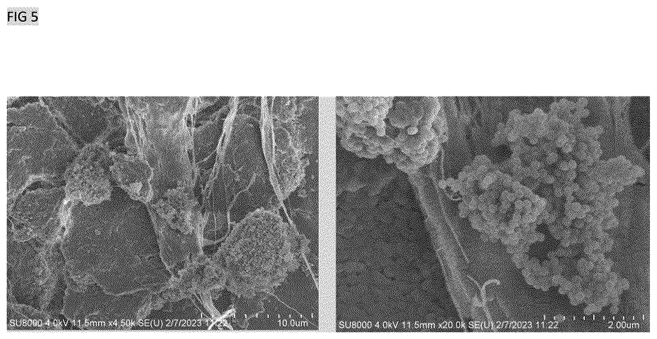

Functionalized PVDF from examples 1 and 4 each separately was combined with PTFE (PVDF/PTFE: 3/1 by weight) to produce scaffolds as described in example 5. Mats were made following this process: The samples were compression molded using a Carver Press and samples were pressed at six metric ton at room temperature for 10 minutes. The tensile bar has a thickness of ˜1000 μm. FIG. 3 shows a picture of the porous mat and confirms the uniform color of this article. This shows that the functionalized PVDF and the PTFE form a single phase. Ultimate tensile strength of these mats was measured according to the ASTM D1708 method and the ultimate tensile were corrected for porosities of these mats. The results are reported in Table 1. The porosity (E) of the sample was measured based the measured density of the mat and calculated density of PVDF and PTFE using the following equation:

$$ϵ = 1 - \frac{measured density}{calculated density}$$

FIG. 3 shows the porous mat made from example 5. The material exhibits homogeneous color. As seen in FIG. 3, the mat has an even color throughout the article, consistent with uniform distribution of PVDF-PTFE in the alloy.

### Example 7 FTIR of Functionalized PVDF and Alloy of Functionalized PVDF-PTFE

The FTIR spectra of PVDF of example 1 and 4, and porous mats of example 6 were measured and the amount of non-α phase PVDF is calculated. For the analysis, the regions 837-840 cm⁻¹ (CH₂ and CF₂ vibrations) as containing high contribution from non-α and 763-765 cm⁻¹ (CF₂ and CCC vibrations) as containing mainly a contributions are selected. For each spectrum, the peak heights are determined (the two selected regions) and a ratio is calculated (peak height at 840 divided by the sum of the two peak heights). The percentage of non-α phase is reported in Table 2.

### Example 8 TGA

Thermal degradation of functionalized PVDF of example 1 and 4, functionalized PVDF (Solef 5130, Synesqo), and alloy of functionalized PVDF-PTFE of example 6 was evaluated by TGA. The decomposition temperature at 5% weight loss is reported in Table 3. The decomposition temperature corresponds to 5% weight loss of the initial mass, when the decomposition starts.

### Example 9 Making Graphite Anode Films

Graphite films were made by mixing graphite active material (C-NERGY™ Actilion GHDR-15-4, Imerys), PTFE (Teflon™ PTFE 601X, Chemours), Kynar® HSV900, Super P (Imerys) and graphite processing aid (C-NERGY™ KS6L, Imerys) in a weight ratio of 93, 1, 3, 1, and 2%. A Thinky mixer (ARE310) was used. First PVDF and Super P were mixed with mixing media (3 beads of 12 mm) at 500 rpm for 90 seconds. Then, active material and KS6L processing aid was added, and this mixture was also mixed at 500 rpm for 90 seconds. PTFE was added, with addition of 4 beads (10 mm) and the mixture was mixed at 2000 rpm for 2 minutes. Total amount of powders used in this sample is 15 g. The malleable sample material was turned into a film at room temperature, and calendered using a horizontal calender at 70° C. The ultimate tensile strength of these samples was measured using the ASTM D1708 method. The ultimate tensile bar was a dog bone, as described in ASTM D1708. The speed used for this experiment was 12.7 mm/min. The samples were processed at room temperature and the ultimate tensile strength was measured in a controlled environment, where the dew point was kept at −5° C. The samples were not conditioned before the ultimate tensile test. Through-plane resistivity of these samples was measured. For through-plane resistivity, the sample was punched to 1″ diameter circles and was placed between two gold plated sheets. The resistance between the two plates, at different applied force, is measured using a Yoogawa resistance meter. The ultimate tensile strength and resistivity of these samples are reported in Table 4.

### Example 10 Making Graphite Anode Films

Graphite films were made by mixing Graphite active material (GHDR-15-4, Imerys), PTFE (601X, Chemours), Kynar® 761, Super P and graphite processing aid (KS6L, Imerys) in a weight ratio of 93, 1, 3, 1, and 2%. A Thinky mixer (ARE310) mixer was used. First PVDF and Super P were mixed with mixing media (3 beads of 12 mm) at 500 rpm for 90 seconds. Then, active material and KS6L processing aid was added, and this mixture was also mixed at 500 rpm for 90 seconds. PTFE was added, with addition of 4 beads (10 mm) and the mixture was mixed at 2000 rpm for 2 minutes. Total amount of powders used in this sample is 15 g. The malleable sample was then turned into the film at room temperature. A freestanding film was formed at room temperature. This film was then calendered at 70° C. Multiple calendering passes were required depending on the target thickness. The ultimate tensile strength of these samples was measured using the ASTM D1708 method. Through-plane resistivity of these samples was measured. The speed used for this experiment was 12.7 mm/min. The ultimate tensile strength was measured in a controlled environment, where the dew point was kept at −5° C. The samples were not conditioned before the tensile test. Through-plane resistivity of these samples was measured. For through-plane resistivity, the sample was punched to 1″ diameter circles and was placed between two gold plated sheets. The resistance between the two plates, at different applied force, is measured using a Yoogawa resistance meter. The ultimate tensile strength and resistivity of these samples are reported in Table 4.

### Example 11 Making Graphite Anode Films

Graphite films were made by mixing Graphite active material (GHDR-15-4, Imerys), PTFE (601X, Chemours), functionalized PVDF of example 1, Super P and graphite processing aid (KS6L, Imerys) in a weight ratio of 93, 1, 3, 1, and 2%. A Thinky mixer (ARE310) mixer was used. First PVDF and Super P were mixed with mixing media (3 beads of 12 mm) at 500 rpm for 90 seconds. Then, active material and KS6L processing aid was added, and this mixture was also mixed at 500 rpm for 90 seconds. PTFE was added, with addition of 4 beads (10 mm) and the mixture was mixed at 2000 rpm for 2 minutes. Total amount of powders used in this sample is 15 g. The malleable sample was then turned into the film at room temperature. A freestanding film was formed at room temperature. This film was then calendered at 70° C. Multiple calendering passes are required depending on the target thickness. The ultimate tensile strength of these samples was measured using the ASTM D1708 method. Through plane resistivity of these samples were measured. The speed used for this experiment was 12.7 mm/min. The ultimate tensile strength was measured in a controlled environment, where the dew point was kept at −5° C. The samples were not conditioned before the tensile test. Through-plane resistivity of these samples was measured. For through-plane resistivity, the sample was punched to 1″ diameter circles and was placed between two gold plated sheets. The resistance between the two plates, at different applied force, is measured using a Yoogawa resistance meter. The ultimate tensile strength and resistivity of these samples are reported in Table 4.

### Example 12 Homopolymer PVDF-PTFE Mixture

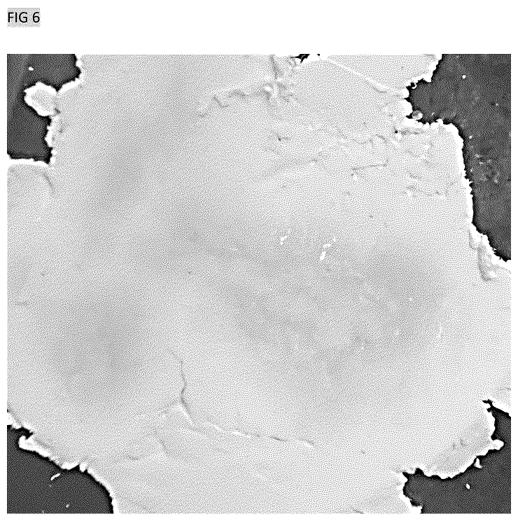

Kynar 741-PTFE mixture was made by shearing 3 g of Kynar 741 PVDF homopolymer and 1 g of PTFE powder at room temperature with total of 7 Zirconia beads of 6.5 mm, using a planetary mixer Thinky ARE-310. The powder was first mixed at 500 rpm for 1 minute, with 2 zirconia beads, followed by shearing at 2000 rpm for 2 mins with total of 7 zirconia beads resulting in formation of PVDF-PTFE blend, FIG. 5.

FIG. 6 is an SEM of Example 12 showing that the PVDF homopolymer (Kynar 741) did not form an alloy with the PTFE. The agglomerated PVDF particles can be seen in the SEM.

### Example 13 Making PVDF-PTFE Porous Mat

Kynar 761 PVDF-PTFE (PVDF/PTFE: 3/1 by weight) samples were made following the process of example 12. The samples were then pressed at six metric ton at room temperature for 10 minutes using a Carver Press and porous mats were fabricated. The tensile bar has a thickness of ˜1000 μm. Ultimate tensile strength of these mats was measured according to the ASTM D1708 method and the ultimate tensile were normalized to account for porosities of these mats and reported in Table 1. Table 1 shows that the mats made from the alloy using functionalized PVDF of example 1 and of example 4, have higher ultimate tensile strength compared to the mat made using the Kynar 761 PVDF-PTFE blend.

FIG. 7 shows the porous mat made. The material exhibits a non-homogeneous composition. As seen in the FIG. 7, the darker shade areas of the mat indicates areas to be of higher density (less porous) than the lighter shade or white areas which are more porous. This shows that the PVDF and PTFE did not form a uniform alloy.

TABLE 1
Ultimate tensile results of PVDF-PTFE porous mats

| | Ultimate Tensile |
|---|---|
| Sample | (kPa) ASTM D1708 |
| 761/PTFE | 830 |
| Example 6 Scaffold of blend of PVDF of example | 1930 |
| 1 with PTFE | |
| Example 6 Scaffold of blend of PVDF of example | 1280 |
| 4 with PTFE | |

### Example 14 FTIR of Pure PVDF and PVDF-PTFE

The FTIR spectra of Kynar® 711, Kynar® 761, Kynar® HSV900, and porous mats of Kynar® 711-PTFE, Kynar® 761-PTFE, and Kynar® HSV900-PTFE, made using the process described in example 13, were measured and the amount of non-α phase for PVDF was calculated. For the analysis, the regions 837-840 cm⁻¹ (CH₂ and CF₂ vibrations) as containing high contribution from non-α and 763-765 cm⁻¹ (CF₂ and CCC vibrations) as containing mainly a contributions are selected. For each spectrum, the peak heights are determined (the two selected regions) and a ratio is calculated. The percentage of non-α phase is reported in Table 2. From this table we can conclude that the percentage of non-α phase of functionalized PVDF of example 1 and 4 is higher than 70%. The percentage of non-α phase increases by mixing PVDF with PTFE. Even after mixing with PTFE, the non-α phase is higher than 70% for the functionalized PVDF of example 1 and 4, while it is still lower than 70% for the nonfunctionalized PVDF-PTFE blend.

TABLE 2
FTIR of pure PVDF and PVDF-PTFE blend samples

| | $\frac{( non - alpha )}{( non - alpha ) + ( alpha )} ( \% )$ | |
|---|---|---|
| Sample | Pure | Sheared with 25% PTFE |
| Kynar ® 711 | 52 | 61 |
| Kynar ® HSV900 | 63 | 68 |
| Kynar ® 761 | 55 | 66 |
| PVDF of example 1 | 72 | 79 |
| PVDF of example 4 | 81 | 90 |

### Example 15 TGA of PVDF and PVDF-PTFE Blend

Thermal degradation of Kynar® 761, Kynar® HSV900 powder and blend of Kynar® 761-PTFE and Kynar® HSV900-PTFE, made using the process described in example 13, was evaluated by TGA. The decomposition temperature at 5% weight loss is reported in Table 3. The decomposition temperature corresponds to 5% weight loss of the initial mass, when the decomposition starts. Based on these results, the thermal degradation of Kynar® 761 is higher than the PVDF of example 1 and example 4. The 5% weight loss temperature of Kynar® 761 is higher than the functionalized PVDF of examples 1 and 4, even after shearing with PTFE.

TABLE 3
Thermal degradation of PVDF

5% weight loss temperature (° C.)

| Sample | Pure | Sheared with 25% PTFE |
|---|---|---|
| Kynar ® HSV900 | 445 | 432 |
| Kynar ® 761 | 441 | 436 |
| PVDF of example 4 | 412 | 420 |
| S5130 | 448 | 454 |

### Counter Example 5

Anode films were made by mixing graphite, conductive carbon, Kynar® 741, and PTFE in a ratio of 95/1/3/1 in a Thinky mixer (no processing aid was added). First PVDF and conductive carbon were mixed at 500 rpm for 90 seconds with 3 Zirconia beads of 12 mm, then graphite was added to the mixture and mixed at 500 rpm for 90 seconds. After addition of PTFE and 5 beads of 10 mm, the mixture was sheared twice at 2000 rpm for 2 minutes and the material was turned into a film at room temperature. Table 4 shows the ultimate tensile results of these samples. By adding the processing aid, a homogenous malleable sample was achieved in the first mix, and therefore there is no need for the second mixing. Based on results from table 4, when a PVDF homopolymer is used, the sample containing the processing aid has higher ultimate tensile (example 9 and 10) compared to the one without the processing aid (counter example 5). Addition of the processing aid does not impact the volume resistivity.

### Counter Example 6

Anode film was made using graphite, conductive carbon, and PTFE in a ratio of 98/1/1 in a Thinky mixer. First graphite and carbon were mixed at 500 rpm with 3 Zirconia beads of 12 mm for 90 seconds. After addition of PTFE and 5 beads of 10 mm, the mixture was sheared twice at 2000 rpm for 2 minutes and the material was turned into a film at room temperature. After the first mix, a compact mixture was formed, with two different textures; A layer on top that can be turned into a film, and a powdery compact material in the bottom. After mixing the sample with a spatula, a second mix at 2000 rpm with mixing media was necessary to obtain a homogenous malleable sample.

TABLE 4
Ultimate tensile strength and volume resistivity results

| | Graphite/ | | | Ulti- | Volume |
|---|---|---|---|---|---|
| | conductive | | | mate | resis- |
| Example/ | carbon/processing | | Thick- | Ten- | tivity |
| counter | aid/PVDF/PTFE | | ness | sile | at 97.7N |
| example | (wt %) | PVDF | (μm) | (KPa) | (Ω · cm) |
| Example 9 | 93/1/2/3/1 | HSV900 | 105 | 480 | 6 |
| Example 10 | 93/1/2/3/1 | 761 | 105 | 210 | 5 |
| Example 11 | 93/1/2/3/1 | PVDF of | 110 | 250 | 4 |
| | | example 1 | | | |
| counter | 95/1/0/3/1 | 741 | 240 | 80 | 7 |
| example 5 | | | | | |
| counter | 98/1/0/0/1 | — | 240 | 70 | — |
| example 6 | | | | | |

1. An anode film comprising: a processing aid, anode active material, optionally a conductive carbon, and a fluoropolymer binder comprising of PVDF and PTFE, wherein the weight ratio of PVDF to PTFE is 10:90 to 95:5; wherein the anode is free of solvent residue, and wherein the total binder amount is from 1 wt % to 10 wt % of the anode film, wherein the processing aid has a number average particle size of less than 5 microns.

2. The anode film of claim 1, wherein the processing aid has an ID/IG of less than 1.6.

3. The anode film of claim 1, wherein the processing aid is a graphite-based processing aid.

4. The anode film of claim 1, wherein the processing aid is selected from the group consisting of graphite powder, graphene, nano graphite, furnace black, acetylene black, carbon nanotubes (CNT), carbon nanofibers (CNF), vapor deposited graphite fibers, Ketjen carbon black and combinations thereof.

5. The anode film of claim 1, wherein the processing aid has a number average particle size of less than 4.0 micrometers.

6. The anode film of claim 1, wherein the processing aid is a flaked graphite having a number average particle size of less than 4.0 micrometers.

7. The anode film of claim 1, wherein the amount of processing aid is from 0.1 to 20 wt % based on the weight of the anode film.

8. The anode film of claim 1, wherein the amount of processing aid is from 0.5 to 5 wt % based on the weight of the anode film.

9. The anode film of claim 1, wherein the PVDF is a homopolymer or vinylidene fluoride copolymer.

10. The anode film of claim 1, wherein the PVDF is a functionalized PVDF comprising a functional group.

11. The anode film of claim 10, wherein the weight ratio of functionalized PVDF to PTFE is from 25:75 to 90:10.

12. The anode film of claim 10, wherein the functional group is selected from the group consisting of a carboxylic group or salt or ester thereof, a phosphate, a sulfonate or a combination thereof.

13. The anode film of claim 10, wherein fluoropolymer binder comprising the PTFE and the functionalized PVDF is in the form of a scaffold.

14. The anode film of claim 1, wherein the amount of fluoropolymer binder in the anode film is from 1 weight % to 6 weight % based on the weight of the anode film.

15. The anode film of claim 1, wherein the anode film contains conductive carbon.

16. An energy storage device comprising the anode film of claim 1, wherein the energy storage device is selected from the group consisting of a lithium-ion battery, a sodium-ion battery and a lithium sulfur battery.

17. A method of fabricating an anode film of an energy storage device, comprising:
a) combining a processing aid, anode active material, optionally conductive carbon, and PVDF to form a first mixture,
b) adding PTFE to the first mixture to form a second mixture; and
c) subjecting the second mixture to a shearing process to form a dry anode forming mixture comprising PVDF and PTFE; wherein no liquid is used in the process.

18. The method of claim 17, wherein the processing aid is selected from the group consisting of graphite powder, graphene, nano graphite, furnace black, acetylene black, carbon nanotubes (CNT), carbon nanofibers (CNF), vapor deposited graphite fibers, Ketjen carbon black and combinations thereof.

19. The method of claim 17, wherein the processing aid has a number average particle size of less than 5.0 micrometers.

20. The method of claim 17, wherein the amount of processing aid is from 0.1 to 20 wt % based on the weight of the anode film.

21. The method of claim 17, wherein combining further comprises combining a conductive carbon with the active material and the PVDF to form the first mixture.
